(19) United States
(12) Patent Application Publication
(10) Pub. No.: US 2025/0093709 A1
(43) Pub. Date: Mar. 20, 2025

(54) ELECTRONIC DEVICE

(71) Applicant: Japan Display Inc., Tokyo (JP)

(72) Inventors: Hitoshi TANAKA, Tokyo (JP); Hirondo NAKATOGAWA, Tokyo (JP); Yoshiro AOKI, Tokyo (JP)

(21) Appl. No.: 18/968,098

(22) Filed: Dec. 4, 2024

Related U.S. Application Data
(63) Continuation of application No. PCT/JP2023/020266, filed on May 31, 2023.

(30) Foreign Application Priority Data
Jun. 6, 2022 (JP) 2022-091501

(51) Int. Cl. G02F 1/1343; G02F 1/1335

(52) U.S. Cl. CPC G02F 1/134309; G02F 1/133512; G02F 1/133514; G02F 1/133524; G02F 1/13439

(57) ABSTRACT

According to one embodiment, in an electronic device, a second lower electrode overlaps with a first upper electrode and a second upper electrode, a third lower electrode overlaps with the first upper electrode and a third upper electrode, a fourth lower electrode overlaps with the second upper electrode, the third upper electrode, and a fourth upper electrode, and a fifth lower electrode overlaps with the second upper electrode, the third upper electrode, and a fifth upper electrode.

### CROSS-REFERENCE TO RELATED APPLICATIONS

This application is a Continuation Application of PCT Application No. PCT/JP2023/020266, filed May 31, 2023, and based upon and claiming the benefit of priority from Japanese Patent Application No. 2022-091501, filed Jun. 6, 2022, the entire contents of all of which are incorporated herein by reference.

### FIELD

Embodiments described herein relate generally to an electronic device.

### BACKGROUND

Electronic devices with smaller and thinner imaging devices have been developed.

### BRIEF DESCRIPTION OF THE DRAWINGS

FIG. 1 is an exploded perspective view showing an example of a schematic configuration of an electronic device applicable in an embodiment.

FIG. 2 is a cross-sectional view showing an example of a schematic configuration of the electronic device shown in FIG. 1.

FIG. 3 is an exploded perspective view schematically showing a partial configuration of the electronic device of the embodiment.

FIG. 4 is a view illustrating a method of measuring the distance using a coded aperture.

FIG. 5 is a plan view showing an example of a schematic configuration of a part of the liquid crystal element.

FIG. 6 is a cross-sectional view showing the liquid crystal element along line A1-A2 shown in FIG. 5.

FIG. 7 is a cross-sectional view showing an example of a schematic configuration of the liquid crystal element.

FIG. 8A is a plan view showing a liquid crystal element of Comparative Example 1.

FIG. 8B is a plan view showing the liquid crystal element of Comparative Example 1.

FIG. 8C is a plan view showing the liquid crystal element of Comparative Example 1.

FIG. 8D is a plan view showing the liquid crystal element of Comparative Example 1.

FIG. 9A is a plan view showing a liquid crystal element of Comparative Example 2.

FIG. 9B is a plan view showing the liquid crystal element of Comparative Example 2.

FIG. 9C is a plan view showing the liquid crystal element of Comparative Example 2.

FIG. 9D is a plan view showing the liquid crystal element of Comparative Example 2.

FIG. 10A is a plan view showing the liquid crystal element of the embodiment.

FIG. 10B is a plan view showing the liquid crystal element of the embodiment.

FIG. 10C is a plan view showing the liquid crystal element of the embodiment.

FIG. 10D is a plan view showing the liquid crystal element of the embodiment.

FIG. 11 is an enlarged view showing a part of FIG. 5.

FIG. 12 is a plan view showing another configuration example of the liquid crystal element of the embodiment.

### DETAILED DESCRIPTION

In general, according to one embodiment, an electronic device comprises
a first upper electrode;
a second upper electrode;
a third upper electrode;
a fourth upper electrode;
a fifth upper electrode;
a first lower electrode connected to the first upper electrode;
a second lower electrode connected to the second upper electrode;
a third lower electrode connected to the third upper electrode;
a fourth lower electrode connected to the fourth upper electrode;
a fifth lower electrode connected to the fifth upper electrode;
an insulating layer provided between the first upper electrode, the second upper electrode, the third upper electrode, the fourth upper electrode, and the fifth upper electrode, and the first lower electrode, the second lower electrode, the third lower electrode, the fourth lower electrode, and the fifth lower electrode;
a counter-electrode facing the first upper electrode, the second upper electrode, the third upper electrode, the fourth upper electrode, and the fifth upper electrode, the first lower electrode, the second lower electrode, the third lower electrode, the fourth lower electrode, and the fifth lower electrode, wherein
the second lower electrode overlaps with the first upper electrode and the second upper electrode,
the third lower electrode overlaps with the first upper electrode and the third upper electrode,
the fourth lower electrode overlaps with the second upper electrode, the third upper electrode, and the fourth upper electrode, and
the fifth lower electrode overlaps with the second upper electrode, the third upper electrode, and the fifth upper electrode.

According to another embodiment, an electronic device comprises
an upper electrode;
a lower electrode; and
an area where the upper electrode and the lower
electrode are not provided, wherein
the upper electrode includes
a center electrode having a circular shape,
a first peripheral electrode surrounding the center electrode and having an annular shape,
a second peripheral electrode surrounding the first peripheral electrode and having an annular shape,
a third peripheral electrode surrounding the second peripheral electrode and having an annular shape, and
a fourth peripheral electrode surrounding the third peripheral electrode and having an annular shape, and
each of the center electrode, the first peripheral electrode, the second peripheral electrode, the third peripheral electrode, and fourth peripheral electrode includes a plurality of divisional electrodes.

Embodiments described herein aim to provide an electronic device capable of suppressing the occurrence of stripes and suppressing the decrease in accuracy can be provided.

Embodiments will be described hereinafter with reference to the accompanying drawings. The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Besides, in the specification and drawings, the same elements as those described in connection with preceding drawings are denoted by like reference numbers, and a detailed description thereof is omitted unless necessary.

The embodiments described herein are not general, but are embodiments that describe the same or corresponding special technical features of the present invention. An electronic device according to an embodiment will be described hereinafter with reference to the accompanying drawings.

In the present embodiment, a first direction X, a second direction Y, and a third direction Z are orthogonal to each other, but may intersect at an angle other than 90 degrees. A direction toward a tip of an arrow of the third direction Z is referred to as an upper or upward direction, and a direction opposite to the direction toward the tip of the arrow of the third direction Z is referred to as a lower or downward direction.

In addition, according to “a second member above a first member” and “a second member below a first member”, the second member may be in contact with the first member or may be located separately from the first member. In the latter case, a third member may be interposed between the first member and the second member. In contrast, according to “a second member on a first member” and “a second member under a first member”, the second member is in contact with the first member.

In addition, an observation position at which the electronic device is to be observed is assumed to be located on the tip side of the arrow of the third direction Z, and viewing from the observation position toward an X-Y plane defined by the first direction X and the second direction Y is referred to as plan view. Viewing a cross-section of the electronic device on an X-Z plane defined by the first direction X and the third direction Z or a Y-Z plane defined by the second direction Y and the third direction Z is referred to as cross-sectional view.

### Embodiment

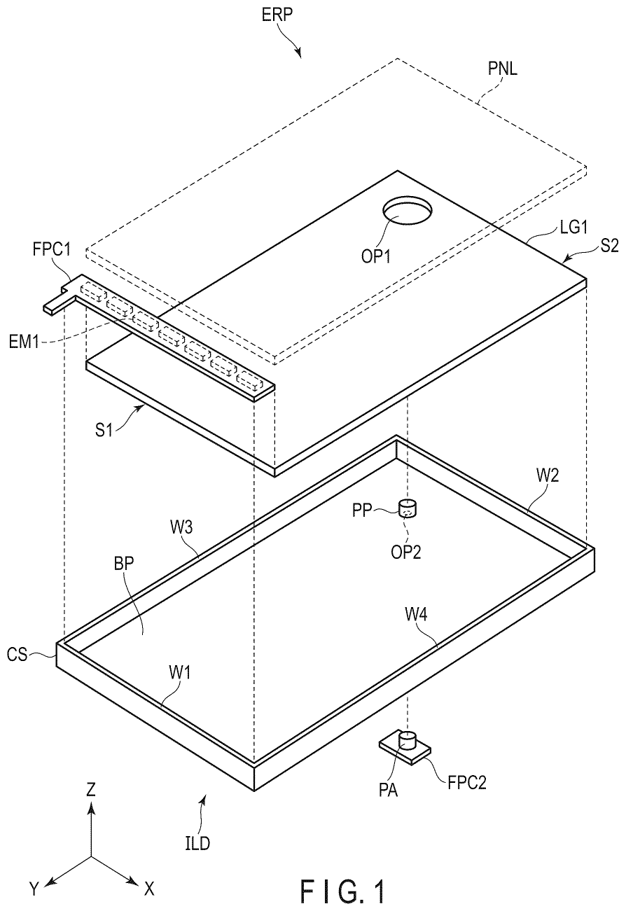

FIG. 1 is an exploded perspective view showing an example of a schematic configuration of an electronic device applicable in an embodiment. The electronic device ERP shown in FIG. 1 includes an illumination device ILD, a display panel PNL, and an image device PA. Although details will be described later, the display panel PNL is a liquid crystal display panel and includes a liquid crystal element LCD.

The illumination device ILD comprises a light guide LG1, light sources EM1, and a housing CS. Such an illumination device ILD illuminates, for example, the display panel PNL which is simply shown by a broken line in FIG. 1.

The light guide LG1 is formed in a flat panel shape parallel to an X-Y plane defined by the first direction X and the second direction Y. The light guide LG1 is opposed to the display panel PNL. The light guide LG1 has a side surface S1, a side surface S2 on the opposite side to the side surface S1, and an aperture OP1. Each of the side surface S1 and the side surface S2 extends along the first direction X. For example, the side surfaces S1 and S2 are the planes parallel to an X-Z plane defined by the first direction X and the third direction Z.

The aperture OP1 is a through hole which penetrates the light guide LG1 along the third direction Z. The aperture OP1 is located between the side surface S1 and the side surface S2 in the second direction Y, and is closer to the side surface S2 than to the side surface S1.

A plurality of light sources EM1 are arranged along the first direction X and spaced apart at intervals. Each of the light sources EM1 is mounted on a wiring board FPC1 and is electrically connected to the wiring board FPC1.

The housing CS accommodates the light guide LG1 and the light sources EM1. The housing CS includes side walls W1 to W4, a bottom plate BP, an aperture OP2, and a protrusion PP. The side wall W1 and the side wall W2 extend along the first direction X and face each other. The side wall W3 and the side wall W4 extend along the second direction Y and face each other. The aperture OP2 is a through hole which penetrates the bottom plate BP along the third direction Z.

The aperture OP2 overlaps with the aperture OP1 in the third direction Z. The protrusion PP is provided to protrude from the bottom plate BP toward the display panel PNL along the direction Z and surround the aperture OP2.

The imaging device PA of the electronic device ERP shown in FIG. 1 is provided to overlap with the aperture OP2 in the third direction Z. The imaging device PA is mounted on a wiring board FPC2 and is electrically connected to the wiring board FPC2.

The display panel PNL overlaps with the light guide LG1 and also overlaps with the imaging device PA at the aperture OP1.

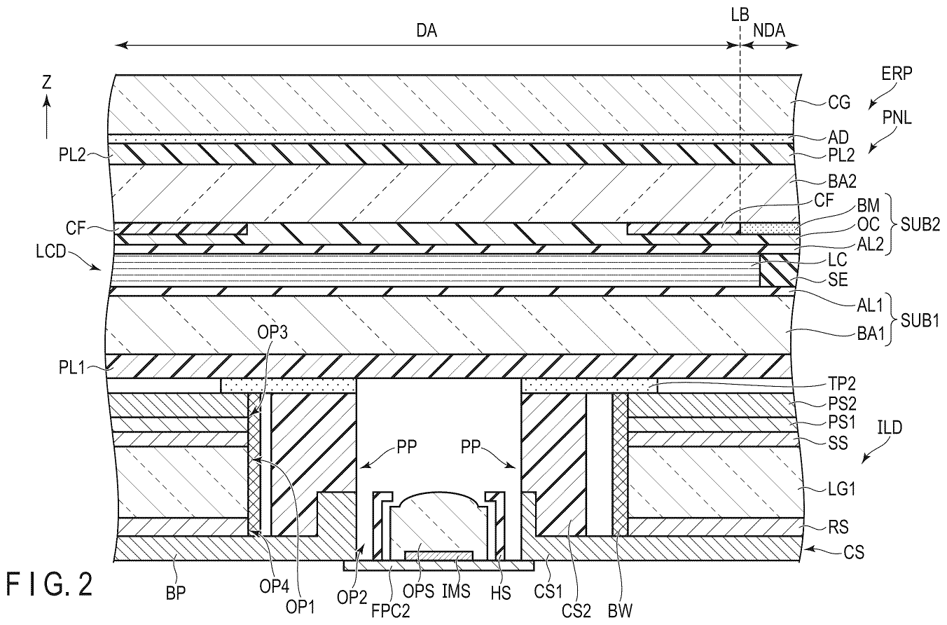

FIG. 2 is a cross-sectional view showing an example of a schematic configuration of the electronic device shown in FIG. 1. FIG. 2 shows a cross section of an electronic device ERP including a display panel PNL, an imaging device PA, and an illumination device ILD.

In the electronic device ERP, the aperture OP2 of the housing CS of the illumination device ILD is located inside the aperture OP1 of the light guide LG1. The imaging device PA is located inside the aperture OP1 and the aperture OP2.

The illumination device ILD further comprises a light shielding wall BW. The light shielding wall BW is located inside the aperture OP1. In the example shown in FIG. 2, the light shielding wall BW is in contact with each of a reflective sheet RS, a light guide LG1, a diffusion sheet SS, a prism sheet PS1, and a prism sheet PS2, which will be described later, but may not be in contact therewith. The light shielding wall BW is formed of, for example, a black colored resin. Incidentally, the light shielding wall BW may not be provided if unnecessary.

The illumination device ILD further comprises a reflective sheet RS, a diffusion sheet SS, a prism sheet PS1, and a prism sheet PS2. The reflective sheet RS, the light guide LG1, the diffusion sheet SS, the prism sheet PS1, and the prism sheet PS2 are arranged in this order along the direction Z and are accommodated in the housing CS. The housing CS comprises a metal housing CS1 and a resin pedestal CS2. The pedestal CS2 forms the protrusion PP together with the housing CS1. Each of the diffusion sheet SS, the prism sheet PS1, and the prism sheet PS2 includes an aperture OP3 that overlaps with the aperture OP1. The reflective sheet RS includes an aperture OP4 that overlaps with the aperture OP1. The protrusion PP of the housing CS is located inside the aperture OP1, the aperture OP3, and the aperture OP4.

The imaging device PA comprises, for example, an optical system OPS including at least one lens, together with a sensor element IMS and a housing HS. The sensor element IMS is an image sensor that can detect images. The optical system OPS and the sensor element IMS are accommodated in the housing HS. The optical system OPS is located between the display panel PNL and the sensor element IMS. The sensor element IMS includes a plurality of sensor elements SX, which will be described later. The plurality of sensor elements SX are also referred to as sensor pixels.

A polarizer PL1, the display panel PNL, a polarizer PL2, and a cover member CG are arranged in this order along the third direction Z, and constitute the liquid crystal element LCD that comprises an optical switching function for light traveling along the third direction Z.

The polarizer PL1 is provided to be in contact with the base BA1 of the substrate SUB1. An adhesive (not shown) or an adhesive tape (not shown) is provided between the polarizer PL1 and the base BA1 (substrate), and the polarizer PL is adhered to the base BA1.

An adhesive tape TP2 is, for example, a transparent or white double-sided adhesive tape, and adheres the illumination device ILD and the liquid crystal element LCD. The adhesive tape TP2 adheres the polarizer PL1 and the protrusion PP, and adheres the polarizer PL1 and the prism sheet PS2.

The polarizer PL2 is bonded to a base BA2 with an adhesive or adhesive tape (not shown). The polarizer PL2 is adhered to the cover member CG by a transparent adhesive layer AD.

The material of the cover member CG is, for example, glass.

The display panel PNL includes a display area DA where images are displayed, and a non-display area NDA adjacent to the display area DA and surrounding the display area DA. The display panel PNL comprises a first substrate SUB1, a second substrate SUB2, a liquid crystal layer LC, and a seal SE. The seal SE is located in the non-display area NDA, adheres the substrate SUB1 and the substrate SUB2, and seals the liquid crystal layer LC. In other words, the display area DA is an area that does not overlap with the seal SE among the areas occupied by the substrate SUB1, the substrate SUB2, and the liquid crystal layer LC sandwiched between the substrate SUB1 and the substrate SUB2.

Main parts of the first substrate SUB1 and the second substrate SUB2 will be described below. The substrate SUB1 comprises the base BA1 and the alignment film AL1. The substrate SUB2 comprises the base BA2, a color filter CF, a light shielding layer BM, an insulating layer OC, and an alignment film AL2.

The base BA1 and the base BA2 are transparent substrates such as glass substrates or flexible resin substrates. The alignment film AL1 and the alignment film AL2 are in contact with the liquid crystal layer LC.

The color filter CF, the light shielding layer BM, and the insulating layer OC are located between the base BA2 and the liquid crystal layer LC. Incidentally, in the example shown in FIG. 2, the color filter CF is provided on the substrate SUB2, but may be provided on the substrate SUB1.

The light shielding layer BM is located in the non-display area NDA. A boundary LB between the display area DA and the non-display area NDA is defined by, for example, an inner edge of the light shielding layer BM (edge part of the display area DA side). The seal SE is provided at a position overlapping with the light shielding layer BM.

Details of the color filter CF are omitted here, but the color filter CF includes, for example, a red color filter provided on a red pixel, a green color filter provided on a green pixel, and a blue color filter provided on a blue pixel. In addition, the color filter CF often comprises a transparent resin layer provided on a white pixel. The insulating layer OC covers the color filter CF and the light shielding layer BM. For example, the insulating layer OC is a transparent organic insulating layer.

In this embodiment, the imaging device PA is, for example, a camera. Incidentally, the imaging device PA may be, for example, a device which detects visible light, a device which detects infrared rays, a proximity sensor which senses the proximity of a detection target, a detection element which detects infrared rays reflected from a detection target, or a combination thereof. The electronic device ERP may comprise a light emitting element instead of or in addition to the imaging device PA. Examples of the light emitting element include a projection element which projects infrared rays toward the detection target.

The imaging device PA is provided so as to overlap with the aperture OP2 of the housing CS, and is located on the inner side surrounded by the protrusion PP. The imaging device PA overlaps with the cover member CG, the display panel PNL, and the light guide LG2 in the third direction Z. Incidentally, a part or all parts of the imaging device PA overlap with the display area DA of the display panel PNL in the third direction Z. In other words, in the electronic device ERP including the display panel PNL and the imaging device PA, the imaging device PA may be provided on the back side of the display panel PNL as viewed from the user of the electronic device ERP.

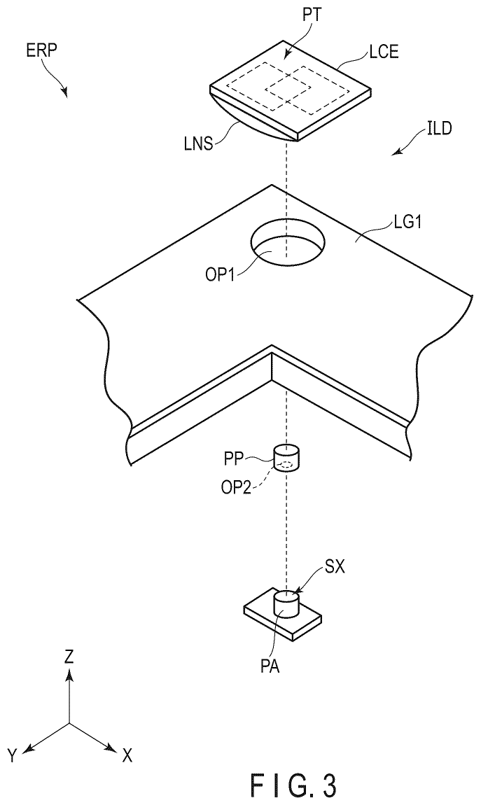

FIG. 3 is an exploded perspective view schematically showing a partial configuration of the electronic device of the embodiment. The electronic device ERP includes a liquid crystal element LCE facing the imaging device PA. The liquid crystal element LCE displays an aperture pattern PT and is provided with a lens LNS. The lens LNS may be provided separately from the liquid crystal element LCE or may be included therein. The lens LNS in FIG. 3 is shown separately from the imaging device PA, and is provided in the optical system OPS as described above. The imaging device PA includes a sensor element SX facing the aperture pattern PT.

In the electronic device ERP, the distance between the imaging device PA and the object is measured by using a coded aperture. In the coded aperture of the embodiment, the distance of the object from the imaging device PA can be estimated by arranging a specific pattern specifying whether or not light is transmitted in front of the imaging device PA. In this case, accuracy can be further improved by using two or more types of coded aperture patterns. For example, a pair of coded aperture patterns is referred to as a coded aperture pair (CAP).

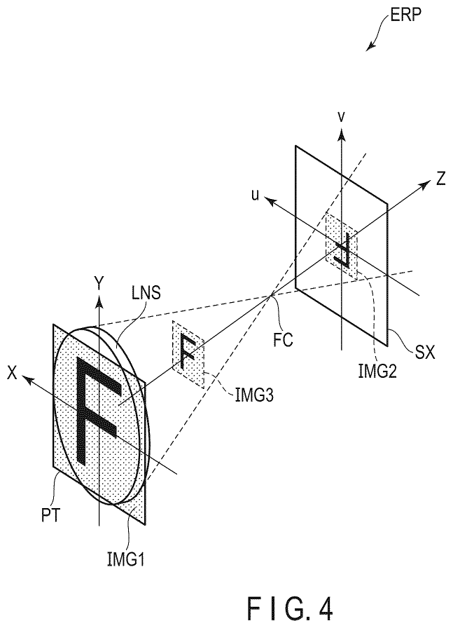

FIG. 4 is a view illustrating a method of measuring the distance using a coded aperture. An image IMG1 on the X-Y plane of an aperture pattern PT of the liquid crystal element LCE is formed on an imaging surface (u-v plane) of the imaging device PA via the lens LNS. A formed image IMG2 is detected by the sensor element SX present on the imaging surface. Information on the light (image) detected by the imaging device PA includes information on the distance from the imaging device PA to the subject.

At this time, an image IMG3 at a position displaced from a focal point FC of the lens LNS becomes a blurred image. If the spread of this blur is calculated as a point spread function (PSF), the distance (depth) can be obtained.

The coded aperture pattern can also be formed by not using the liquid crystal element, but using a light shielding layer formed of, for example, a metal material. In the case of a light shielding layer formed of a metal material, however, the type of the coded aperture pattern is limited. The electronic device ERP of the embodiment has an advantage of being capable of using two or more types of coded aperture patterns by comprising the liquid crystal element LCE.

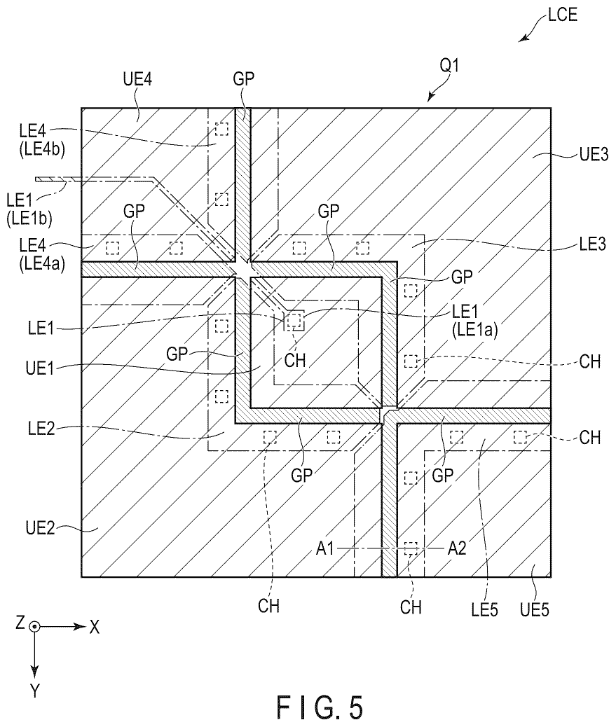

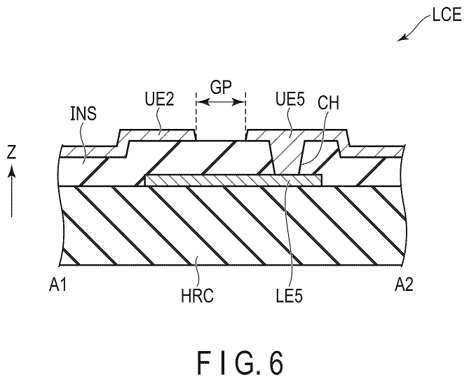

FIG. 5 is a plan view showing an example of a schematic configuration of a part of the liquid crystal element. FIG. 6 is a cross-sectional view showing the liquid crystal element along line A1-A2 shown in FIG. 5. The liquid crystal element LCE includes a lower electrode LE1, a lower electrode LE2, a lower electrode LE3, a lower electrode LE4, a lower electrode LE5, an upper electrode UE1, an upper electrode UE2, an upper electrode UE3, an upper electrode UE4, and an upper electrode UE5, and a contact hole CH.

The upper electrode UE1 has a square shape and is arranged near the center of the liquid crystal element LCE. The upper electrode UE2, the upper electrode UE3, the upper electrode UE4, and the upper electrode UE5 are arranged to surround the upper electrode UE1. The upper electrode UE2, the upper electrode UE3, the upper electrode UE4, and the upper electrode UE5 constitute an electrode Q1 shaped in a hollow square. A gap GP is provided between the upper electrode UE1, the upper electrode UE2, the upper electrode UE3, the upper electrode UE4, and the upper electrode UE5 such that they are not brought into contact with each other.

The upper electrode UE1 is a center electrode located at the center of these electrodes, and the upper electrode UE2, the upper electrode UE3, the upper electrode UE4, and the upper electrode UE5 arranged to surround the upper electrode UE1 are considered as peripheral electrodes surrounding the center electrode. The upper electrode UE2, the upper electrode UE3, the upper electrode UE4, and the upper electrode UE5 are also considered as divisional electrodes obtained by dividing the peripheral electrode by the gap GP.

The positional relationship among the upper electrode UE2, the upper electrode UE3, the upper electrode UE4, and the upper electrode UE5 will be described. The upper electrode UE2 has an L-shape and is adjacent to the upper electrode UE5 in the first direction X. The upper electrode UE2 is adjacent to the upper electrode UE4 in the opposite direction to the second direction Y.

The upper electrode UE3 has a shape obtained by rotating an L shape by 180 degrees. The upper electrode UE3 is adjacent to the upper electrode UE4 in the opposite direction to the first direction X. The upper electrode UE3 is adjacent to the upper electrode UE5 in the second direction Y.

The upper electrode UE4 has a rectangular shape and is adjacent to the upper electrode UE3 in the first direction X. The upper electrode UE4 is adjacent to the upper electrode UE2 in the second direction Y.

The upper electrode UE5 has a rectangular shape and is adjacent to the upper electrode UE2 in the opposite direction to the first direction X. The upper electrode UE5 is adjacent to the upper electrode UE3 in the opposite direction to the second direction Y.

As shown in FIG. 5, the lower electrode LE1 includes a rectangular electrode portion LE1a and a wiring portion LE1b, which are integrally formed. The electrode portion LE1a overlaps with the upper electrode UE1 in plan view.

The lower electrode LE4 includes two electrode portions LE4a and LE4b provided in the same layer. The wiring portion LE1b is provided between the electrode portion LE4a and the electrode portion LE4b in plan view. The wiring portion LE1b is not in contact with the electrode portion LE4a and the electrode portion LE4b provided in the same layer and is drawn out to the outside of the liquid crystal element LCE.

The lower electrode LE2 is provided to overlap with an end part of each of the upper electrode UE2 and the upper electrode UE1, and fill the gap GP between the upper electrode UE2 and the upper electrode UE1. In an area where the lower electrode LE2 and the upper electrode UE2 overlap, the contact hole CH is provided in an insulating layer INS, which will be described later.

The lower electrode LE3 is provided so as to overlap with an end part of each of the upper electrode UE3 and the upper electrode UE1, and fill the gap GP between the upper electrode UE3 and the upper electrode UE1. In an area where the lower electrode LE3 and the upper electrode UE3 overlap, the contact hole CH is provided in the insulating layer INS.

As described above, the lower electrode LE4 includes the electrode portion LE4a and the electrode portion LE4b. The electrode portion LE4a is provided so as to overlap with an end part of each of the upper electrode UE4 and the upper electrode UE2, and fill the gap GP between the upper electrode UE4 and the upper electrode UE2. In an area where the lower electrode LE4a and the upper electrode UE4 overlap, the contact hole CH is provided in the insulating layer INS.

The electrode portion LE4b is provided so as to overlap with an end part of each of the upper electrode UE4 and the upper electrode UE3, and fill the gap GP between the upper electrode UE4 and the upper electrode UE3. In an area where the lower electrode LE4b and the upper electrode UE4 overlap, the contact hole CH is provided in the insulating layer INS.

The lower electrode LE5 overlaps with the end part of each of the upper electrode UE5 and the upper electrode UE2, and the end part of each of the upper electrode UE5 and the upper electrode UE3. The lower electrode LE5 is provided so as to fill the gap GP between the upper electrode UE5 and the upper electrode UE2, and the gap GP between the upper electrode UE5 and the upper electrode UE3. Contact holes CH are provided in the insulating layer INS, in the area where the upper electrode UE5 and the upper electrode UE2 overlap and the area where the upper electrode UE5 and the upper electrode UE3 overlap.

In the embodiment, the lower electrode LE1, the lower electrode LE2, the lower electrode LE3, the lower electrode LE4, and the lower electrode LE5 are provided on the insulating layer HRC. The insulating layer HRC may be formed of an organic resin layer, more specifically, acrylic resin or polyimide resin. The lower electrode LE1, the lower electrode LE2, the lower electrode LE3, the lower electrode LE4, and the lower electrode LE5, and the upper electrode UE1, the upper electrode UE2, the upper electrode UE3, the upper electrode UE4, and the upper electrode UE5, may be formed of a transparent conductive material, for example, indium tin oxide (ITO) or indium zinc oxide (IZO).

As shown in FIG. 6, the lower electrode LE5 is covered with the insulating layer INS. The insulating layer INS may be formed of an inorganic insulating material, for example, silicon nitride or silicon oxide. The contact hole CH overlapping with the lower electrode LE5 is provided in the insulating layer INS.

The upper electrode UE2 and the upper electrode UE5 are provided on the insulating layer INS. The upper electrode UE5 is connected to the lower electrode LE5 through the contact hole CH. The upper electrode UE2 is not connected to the lower electrode LE5.

FIG. 6 shows the lower electrode LE5 and upper electrode UE5. The lower electrodes LE1, the lower electrode LE2, the lower electrode LE3, and the lower electrode LE4, and the upper electrode UE1, the upper electrode UE2, the upper electrode UE3, and the upper electrode UE4 are configured in the same manner. In other words, the upper electrode UE1 is connected to the lower electrode LE1 through the contact hole CH. The upper electrode UE2 is connected to the lower electrode LE2 through the contact holes CH. The upper electrode UE3 is connected to the lower electrode LE4 through the contact holes CH. The upper electrode UE4 is connected to the lower electrode LE4 through the contact holes CH.

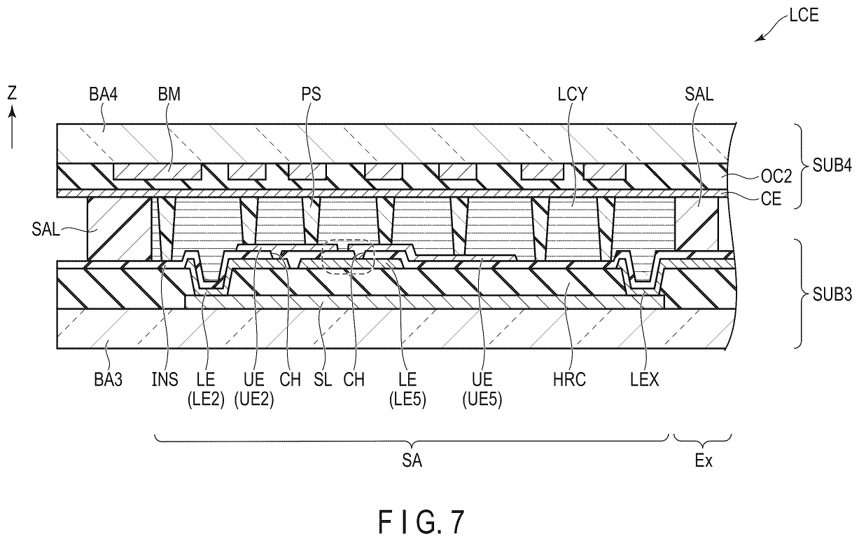

FIG. 7 is a cross-sectional view showing an example of a schematic configuration of the liquid crystal element. The liquid crystal element LCE comprises a base BA3, a signal line SL, an insulating layer HRC, lower electrodes LE, an electrode LEX, an insulating layer INS, upper electrodes UE, a spacer PS, a liquid crystal layer LCY, a counter-electrode CE, an insulating layer OC2, a light shielding layer BM, and a base BA4.

The base BA3, the signal line SL, the insulating layer HRC, the lower electrodes LE, the electrode LEX, the insulating layer INS, and the upper electrodes UE constitute a substrate SUB3. The counter-electrode CE, the insulating layer OC2, the light shielding layer BM, and the base BA4 constitute a substrate SUB4.

In FIG. 7, the part surrounded by a dotted line corresponds to FIG. 6.

The liquid crystal element LCE includes a sensor area SA and an end portion Ex. The sensor area SA mainly includes the lower electrodes LE, the upper electrodes UE, the liquid crystal layer LCY, and the counter-electrode CE. The liquid crystal layer LCY is provided between the upper electrodes UE and the lower electrodes LE, and the counter-electrode CE.

The electrode LEX connected to the signal line SL is provided at the end portion Ex. The electrode LEX is electrically connected to an external drive element. However, the configuration of the end portion Ex is not limited to this, but wires and electrodes for inputting a drive signal from an external drive element may be provided.

The base BA3 and the base BA4 may be formed of a transparent insulating member, for example, glass.

The signal line SL is provided on the base BA3. The signal line SL may be formed of a metal material, for example, a multilayer body formed by sandwiching aluminum between titanium.

The insulating layer HRC is provided to cover the base BA3 and the signal line SL. The insulating layer HRC functions as a planarizing layer.

The lower electrodes LE and the electrode LEX are provided on the insulating layer HRC. The lower electrodes LE and the electrode LEX are the electrodes provided in the same layer. In other words, the lower electrodes LE and the electrode LEX are formed of the same material with the same configuration.

FIG. 7 shows the lower electrode LE2 and the lower electrode LE5 among the lower electrodes LE. The lower electrode LE2 is connected to the signal line SL through a contact hole provided in the insulating layer HRC. Although not shown, the lower electrode LE5 is also connected to the other signal line SL. A signal is input to the lower electrodes LE (lower electrode LE2 and lower electrode LE5) via the signal line SL, and the on state and the off state are controlled.

The insulating layer INS is provided to cover the lower electrodes LE and the electrode LEX.

The upper electrodes UE are provided on the insulating layer INS. FIG. 7 shows the upper electrode UE2 and the upper electrode UE5 among the upper electrodes UE. The upper electrode UE2 is connected to the lower electrode LE2 through the contact hole CH provided in the insulating layer INS. The upper electrode UE5 is connected to the lower electrode LE5 through the contact hole CH provided in the insulating layer INS.

A seal SAL, a spacer PS, a conductive member CM, and a liquid crystal layer LCY are provided on the insulating layer INS and the upper electrodes UE.

The seal SAL is provided so as to surround the liquid crystal layer LCY. An area surrounded by the seal SAL and provided with the liquid crystal layer LCY becomes the sensor area SA. The seal SAL adheres the substrate SUB3 and the substrate SUB4 and seals the liquid crystal layer LCY.

The spacer PS is arranged inside the area where the liquid crystal layer LCY is provided. The spacer PS has a function of maintaining the thickness of the liquid crystal layer LCY. The spacer PS may be formed of an organic resin material.

The light shielding layer BM is provided to be in contact with the base BA4. The light shielding layer BM is arranged at a position facing the spacer PS. Examples of the material of the light shielding layer BM include metal materials and resin materials containing black pigment.

The insulating layer OC2 is provided to cover the base BA4 and the light shielding layer BM. For example, the insulating layer OC2 is a transparent organic insulating layer.

The counter-electrode CE is provided to be in contact with the insulating layer OC2. The counter-electrode CE may be formed of a transparent conductive material such as indium tin oxide (ITO) or indium zinc oxide (IZO). The counter-electrode CE faces the upper electrode UE and the lower electrode LE.

When the liquid crystal element LCE is driven in the vertical electric field mode, the liquid crystal layer LCY is driven by a voltage applied between the upper electrode UE, the lower electrode LE, and the counter-electrode CE. By driving the voltage, an area where white display is made and an area where black display is made are switched, and an aperture pattern PT of the liquid crystal element LCE is formed.

An example in which the lower electrode LE is not provided will be considered as a comparative example. A case in which the lower electrode LE is not provided, i.e., only the upper electrode UE is provided will be described as comparative example 1.

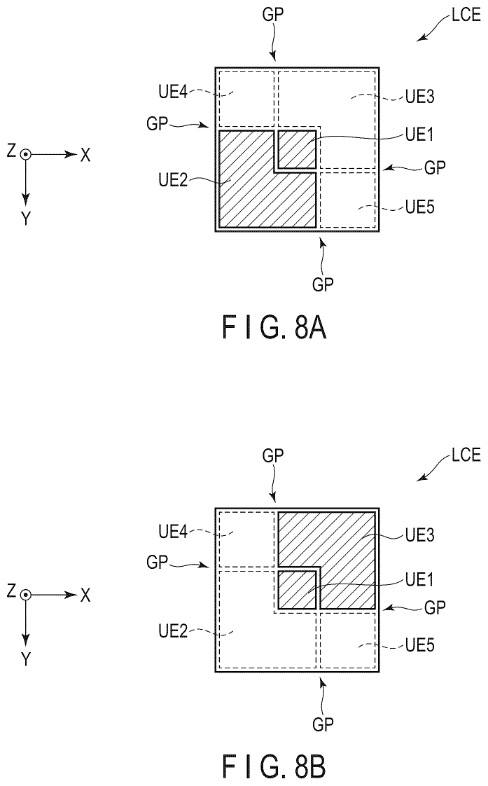

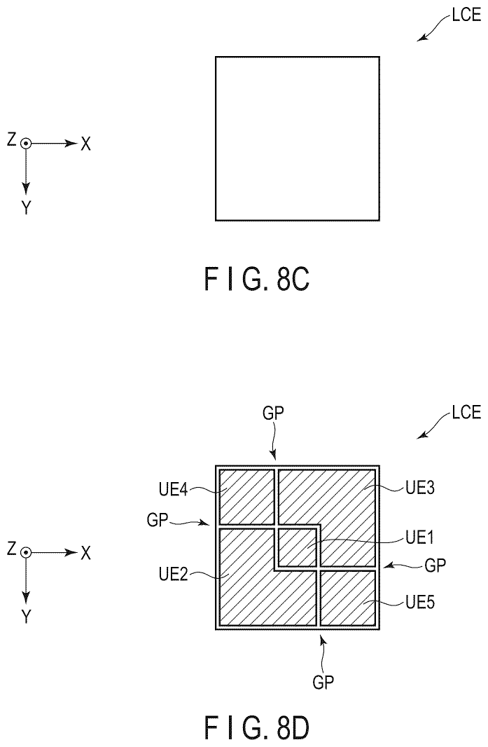

FIG. 8A to FIG. 8D are plan views showing the liquid crystal element of comparative example 1. In FIG. 8A, the upper electrode UE3, the upper electrode UE4, and the upper electrode UE5 are in the on state, and the upper electrode UE1 and the upper electrode UE2 are in the off state. The area where the upper electrode UE3, the upper electrode UE4, and the upper electrode UE5 allows light to be transmitted, and so-called white display is made. The area where the upper electrode UE1 and the upper electrode UE2 does not allow light to be transmitted, and so-called black display is made.

An electrode for driving the liquid crystal layer LCY is not arranged in the gap GP between the upper electrode UE1 and the upper electrode UE2. For this reason, the liquid crystal layer LCY allows light to be transmitted and so-called white display is made. Therefore, the area corresponding to the gap GP between the upper electrode UE1 and the upper electrode UE2 is detected as a white stripe.

In FIG. 8B, the upper electrode UE2, the upper electrode UE4, and the upper electrode UE5 are in the on state, and the upper electrode UE1 and the upper electrode UE3 are in the off state. In FIG. 8B as well, the area corresponding to the gap GP between the upper electrode UE1 and the upper electrode UE3 is detected as a white stripe.

In FIG. 8C, all the upper electrode UE1, the upper electrode UE2, the upper electrode UE3, the upper electrode UE4, and the upper electrode UE5 are in the on state. White display is made in the area where the upper electrode UE1, the upper electrode UE2, the upper electrode UE3, the upper electrode UE4, and the upper electrode UE5 are provided, and the area corresponding to the gap GP. The areas are in a so-called all-white display state. In FIG. 8C, no stripes are detected.

In FIG. 8D, oppositely to FIG. 8C, all the upper electrode UE1, the upper electrode UE2, the upper electrode UE3, the upper electrode UE4, and the upper electrode UE5 are in the off state. The area where the upper electrode UE1, the upper electrode UE2, the upper electrode UE3, the upper electrode UE4, and the upper electrode UE5 are provided does not allow light to be transmitted, and so-called black display is made. The areas are in a so-called all-black display state.

As described above, however, light is transmitted through the liquid crystal layer LCY in the area corresponding to the gap GP. For this reason, white display is made in the entire area corresponding to the gap GP, and white stripes are remarkably detected.

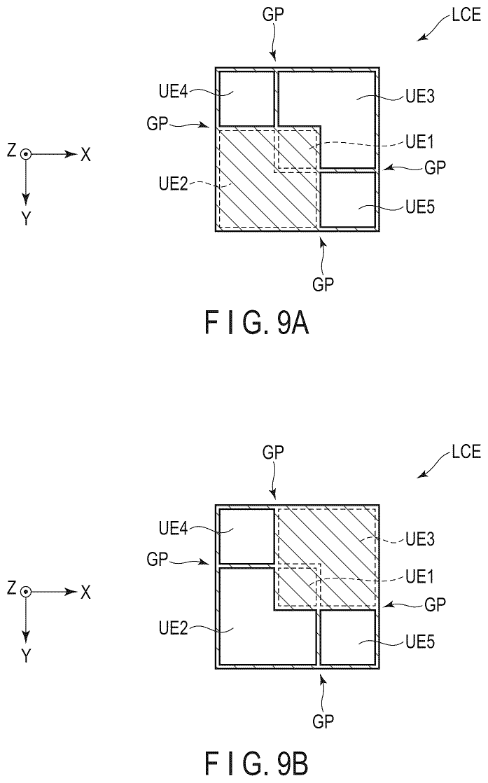

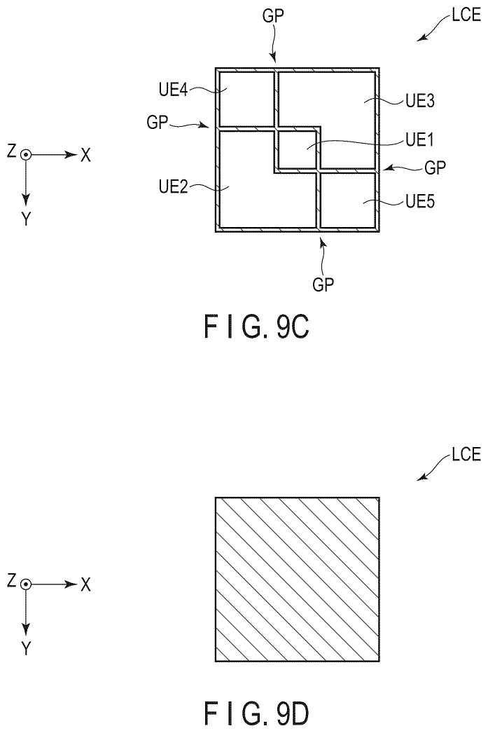

In order to prevent white stripes shown in FIG. 8B to FIG. 8D, for example, providing a light shielding layer in the area corresponding to the gap GP is considered. FIG. 9A to FIG. 9D are plan views showing a liquid crystal element of Comparative Example 2. In Comparative Example 2, a light shielding layer is provided in an area corresponding to the gap GP.

In FIG. 9A, the upper electrode UE3, the upper electrode UE4, and the upper electrode UE5 are in the on state, and the upper electrode UE1 and the upper electrode UE2 are in the off state. The area where the upper electrode UE3, the upper electrode UE4, and the upper electrode UE5 allows light to be transmitted, and so-called white display is made. The area where the upper electrode UE1 and the upper electrode UE2 does not allow light to be transmitted, and so-called black display is made.

Since a light shielding layer is provided in the gap GP between the upper electrode UE3 and the upper electrode UE4 and the gap GP between the upper electrode UE3 and the upper electrode UE5, light is not transmitted. For this reason, the gaps GP are detected as black stripes.

In FIG. 9B, the upper electrode UE2, the upper electrode UE4, and the upper electrode UE5 are in the on state, and the upper electrode UE1 and the upper electrode UE3 are in the off state. In FIG. 8B as well, areas corresponding to the gap GP between the upper electrode UE2 and the upper electrode UE4 and the gap GP between the upper electrode UE2 and the upper electrode UE5 are detected as black stripes.

In FIG. 9C, all the upper electrode UE1, the upper electrode UE2, the upper electrode UE3, the upper electrode UE4, and the upper electrode UE5 are in the on state. White display is made in the area where the upper electrode UE1, the upper electrode UE2, the upper electrode UE3, the upper electrode UE4, and the upper electrode UE5 are provided. The areas are in a so-called all-white display state.

Light is not transmitted through the entire area corresponding to the gap GP, and black stripes are remarkably detected.

In FIG. 9D, oppositely to FIG. 8C, all the upper electrode UE1, the upper electrode UE2, the upper electrode UE3, the upper electrode UE4, and the upper electrode UE5 are in the off state. The area where the upper electrode UE1, the upper electrode UE2, the upper electrode UE3, the upper electrode UE4, and the upper electrode UE5 are provided, and the area corresponding to the gap GP do not allow light to be transmitted, and so-called black display is made. The areas are in a so-called all-black display state. In FIG. 9D, no stripes are detected.

Detecting undesired white stripes or black stripes by the sensor element SX leads to a decrease in accuracy of the electronic device ERP. Therefore, it is desirable to suppress the occurrence of the stripes. Even if a location through which light is passed or a location through which light is not passed is present and the part is minute, the detection using the sensor element SX is not affected. The decrease in accuracy can be thereby suppressed.

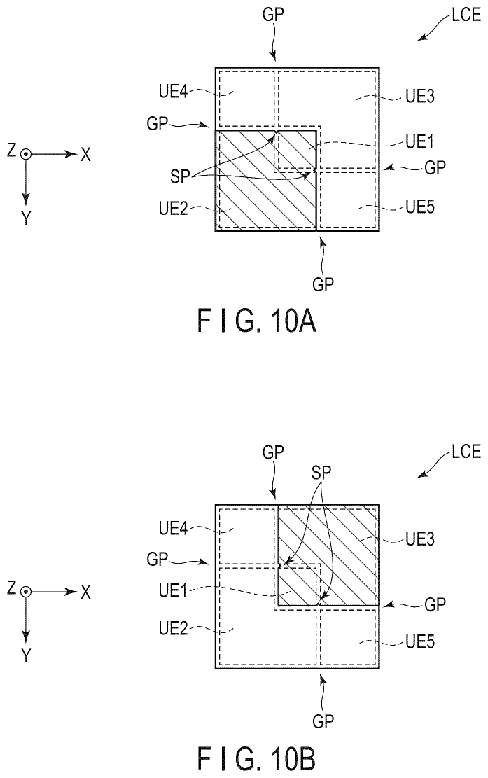

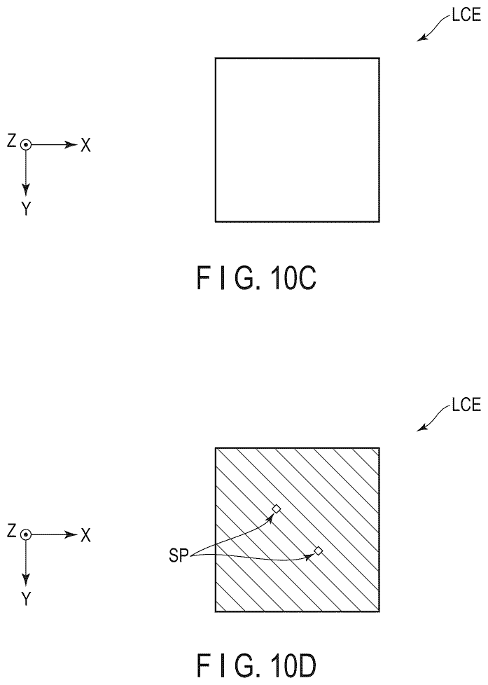

FIG. 10A to FIG. 10D are plan views showing the liquid crystal element of the embodiment. In the liquid crystal element LCE of the embodiment, the lower electrode LE is provided as described with reference to FIG. 5. As described with reference to FIG. 6, the lower electrode LE is connected to the upper electrode UE, and the same voltage is applied thereto.

In FIG. 10A, the upper electrode UE3, the upper electrode UE4, and the upper electrode UE5 are in the on state, and the upper electrode UE1 and the upper electrode UE2 are in the off state. The liquid crystal element LCE shown in FIG. 10A is different from the liquid crystal element LCE shown in FIG. 8A in that a lower electrode is provided so as to fill the gap GP between the upper electrode UE1 and the upper electrode UE2 (see FIG. 5). Since the lower electrode LE2 has the same potential as the upper electrode UE2, the lower electrode LE2 is in the off state. As a result, black display is also made in the area corresponding to the gap GP, and no white stripes are detected.

In FIG. 10B, the upper electrode UE2, the upper electrode UE4, and the upper electrode UE5 are in the on state, and the upper electrode UE1 and the upper electrode UE3 are in the off state. As shown in FIG. 5, the lower electrode LE3 is provided so as to fill the gap GP between the upper electrode UE1 and the upper electrode UE3. For this reason, since the lower electrode LE3 has the same potential as the upper electrode UE3, the lower electrode LE3 is in an off state. As a result, black display is also made in the area corresponding to the gap GP, and no white stripes are detected.

In FIG. 10C, all the upper electrode UE1, the upper electrode UE2, the upper electrode UE3, the upper electrode UE4, and the upper electrode UE5 are in the on state. Since the lower electrode LE1, the lower electrode LE2, the lower electrode LE3, the lower electrode LE4, and the lower electrode LE5, which are connected to each other, are also in the on state, no black stripes are detected.

In FIG. 10D, all the upper electrode UE1, the upper electrode UE2, the upper electrode UE3, the upper electrode UE4, and the upper electrode UE5 are in the off state. Since all the lower electrode LE1, the lower electrode LE2, the lower electrode LE3, the lower electrode LE4, and the lower electrode LE5 are in the off state, no white stripes are detected.

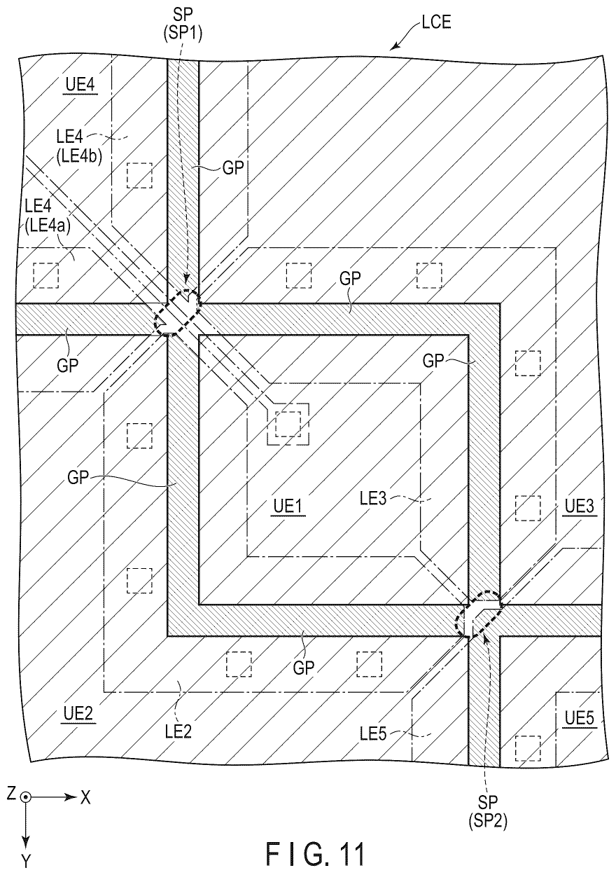

As shown in FIG. 5, however, there are locations where electrodes cannot be provided in order to separate the lower electrodes LE from each other. FIG. 11 is an enlarged view showing a part of FIG. 5. As shown in FIG. 11, neither the lower electrode nor the upper electrode is provided in an area SP1 where end portions of the lower electrode LE2, the lower electrode LE3, the lower electrode LE4a, and the lower electrode LE4b are adjacent to each other, and an area SP2 where end portions of the lower electrode LE2, the lower electrode LE3, and the lower electrode LE5 are adjacent to each other. When the area SP1 and the area SP2 do not need to be particularly distinguished, they are simply referred to as the area SP.

In the area SP, no voltage can be applied to the liquid crystal layer LCY. For this reason, when black display is made in the liquid crystal layer LCY, the area SP may be detected as a white dot (see FIG. 10D). However, the dot is less likely to be detected than the stripes described in Comparative Example 1 and Comparative Example 2.

Although not described above, the area SP also exists in FIG. 10A and FIG. 10B. However, since no stripes are formed and are smaller than the area where black display is made, the accuracy of the electronic device ERP is not affected.

In the embodiment, both the upper electrode UE and the lower electrode LE are formed of a transparent conductive material, for example, indium tin oxide (ITO) or indium zinc oxide (IZO). For this reason, a light shielding layer as shown in FIG. 9A to FIG. 9D is unnecessary.

As described above, according to the embodiment, an electronic device capable of suppressing the occurrence of stripes and suppressing the decrease in accuracy can be provided.

### Configuration Example 1

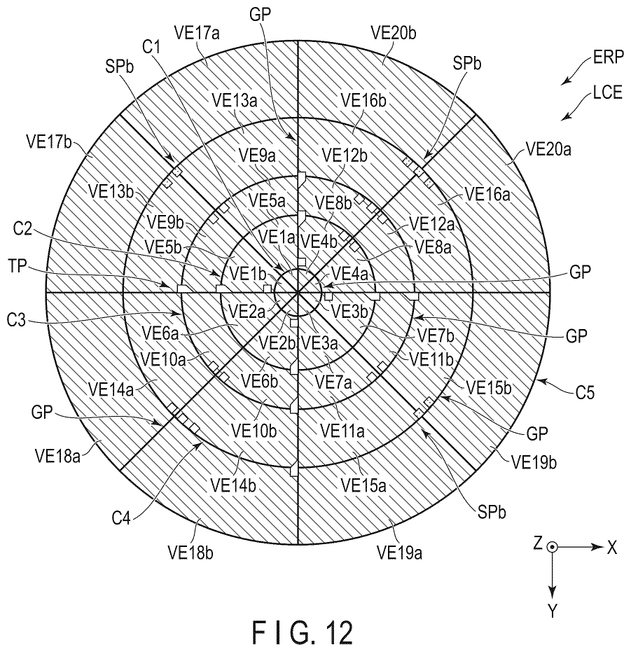

FIG. 12 is a plan view showing another configuration example of the liquid crystal element of the embodiment. The configuration example shown in FIG. 12 is different from the configuration example shown in FIG. 5 in that the electrode has a circular shape.

The liquid crystal element LCE includes an upper electrode VE1a, an upper electrode VE1b, an upper electrode VE2a, an upper electrode VE2b, an upper electrode VE3a, an upper electrode VE3b, an upper electrode VE4a, an upper electrode VE4b, an upper electrode VE5a, an upper electrode VE5b, an upper electrode VE6a, an upper electrode VE6b, an upper electrode VE7a, an upper electrode VE7b, an upper electrode VE8a, an upper electrode VE8b, an upper electrode VE9a, an upper electrode VE9b, an upper electrode VE10a, an upper electrode VE10b, an upper electrode VE11a, an upper electrode VE11b, an upper electrode VE12a, an upper electrode VE12b, an upper electrode VE13a, an upper electrode VE13b, an upper electrode VE14a, an upper electrode VE14b, an upper electrode VE15a, an upper electrode VE15b, an upper electrode VE16a, an upper electrode VE16b, an upper electrode VE17a, an upper electrode VE17b, an upper electrode VE18a, an upper electrode VE18b, an upper electrode VE19a, an upper electrode VE19b, an upper electrode VE20a, and an upper electrode VE20b.

The upper electrode VE1a, the upper electrode VE1b, the upper electrode VE2a, the upper electrode VE2b, the upper electrode VE3a, the upper electrode VE3b, the upper electrode VE4a, and the upper electrode VE4b are arranged adjacent to each other to constitute a circular electrode C1. Gaps GP are provided between the upper electrode VE1a, the upper electrode VE1b, the upper electrode VE2a, the upper electrode VE2b, the upper electrode VE3a, the upper electrode VE3b, the upper electrode VE4a, and the upper electrode VE4b.

Although not shown to make the drawing easier to understand, wires are provided between the upper electrode VE1a and the upper electrode VE1b, between the upper electrode VE2a and the upper electrode VE2b, between the upper electrode VE3a and the upper electrode VE3b, and between the upper electrode VE4a and the upper electrode 4b.

The upper electrode VE5a, the upper electrode VE5b, the upper electrode VE6a, the upper electrode VE6b, the upper electrode VE7a, the upper electrode VE7b, the upper electrode VE8a, and the upper electrode VE8b are arranged adjacent to each other to constitute an annular electrode C2. The electrode C2 is arranged at a position surrounding the electrode C1. Gaps GP are provided between the upper electrode VE5a, the upper electrode VE5b, the upper electrode VE6a, the upper electrode VE6b, the upper electrode VE7a, the upper electrode VE7b, the upper electrode VE8a, and the upper electrode VE8b. A gap GP is also provided between the electrode C1 and the electrode C2.

Although not shown to make the drawing easier to understand, wires are provided between the upper electrode VE5a and the upper electrode VE5b, between the upper electrode VE6a and the upper electrode VE6b, between the upper electrode VE7a and the upper electrode VE7b, and between the upper electrode VE8a and the upper electrode 8b.

The upper electrode VE9a, the upper electrode VE9b, the upper electrode VE10a, the upper electrode VE10b, the upper electrode VE11a, the upper electrode VE11b, the upper electrode VE12a, and the upper electrode VE12b are arranged adjacent to each other to constitute an annular electrode C3. The electrode C3 is arranged at a position surrounding the electrode C2. Gaps GP are provided between the upper electrode VE9a, the upper electrode VE9b, the upper electrode VE10a, the upper electrode VE10b, the upper electrode VE11a, the upper electrode VE11b, the upper electrode VE12a, and the upper electrode VE12b. A gap GP is also provided between the electrode C2 and the electrode C3.

Although not shown to make the drawing easier to understand, wires are provided between the upper electrode VE9a and the upper electrode VE9b, between the upper electrode VE10a and the upper electrode VE10b, between the upper electrode VE11a and the upper electrode VE11b, and between the upper electrode VE12a and the upper electrode 12b.

The upper electrode VE13a, the upper electrode VE13b, the upper electrode VE14a, the upper electrode VE14b, the upper electrode VE15a, the upper electrode VE15b, the upper electrode VE16a, and the upper electrode VE16b are arranged adjacent to each other to constitute an annular electrode C4. The electrode C4 is arranged at a position surrounding the electrode C3. Gaps GP are provided between the upper electrode VE13a, the upper electrode VE13b, the upper electrode VE14a, the upper electrode VE14b, the upper electrode VE15a, the upper electrode VE15b, the upper electrode VE16a, and the upper electrode VE16b. A gap GP is also provided between the electrode C3 and the electrode C4.

Although not shown to make the drawing easier to understand, wires are provided between the upper electrode VE13a and the upper electrode VE13b, between the upper electrode VE14a and the upper electrode VE14b, between the upper electrode VE14a and the upper electrode VE14b, and between the upper electrode VE15a and the upper electrode 15b.

The upper electrode VE17a, the upper electrode VE17b, the upper electrode VE18a, the upper electrode VE18b, the upper electrode VE19a, the upper electrode VE19b, the upper electrode VE20a, and the upper electrode VE20b are arranged adjacent to each other to constitute an annular electrode C5. The electrode C5 is arranged at a position surrounding the electrode C4. Gaps GP are provided between the upper electrode VE17a, the upper electrode VE17b, the upper electrode VE18a, the upper electrode VE18b, the upper electrode VE19a, the upper electrode VE19b, the upper electrode VE20a, and the upper electrode VE20b. A gap GP is also provided between the electrode C4 and the electrode C5.

The circular electrode C1 is a center electrode located at the center of the above-described electrodes. The annular electrode C2 arranged to surround the electrode C1 is also considered to be a first peripheral electrode surrounding the center electrode. The upper electrode VE5a, the upper electrode VE5b, the upper electrode VE6a, the upper electrode VE6b, the upper electrode VE7a, the upper electrode VE7b, the upper electrode VE8a, and the upper electrode VE8b are considered to be divisional electrodes obtained by dividing the first peripheral electrode by the gaps GP. The electrode C3, the electrode C4, and the electrode C5 may also be referred to as a second peripheral electrode, a third peripheral electrode, and a fourth peripheral electrode, respectively, similarly to the electrode C2.

Although not shown in order to avoid the drawing complicated, lower electrodes are provided in the liquid crystal element LCE shown in FIG. 12. Similar to FIG. 11, the liquid crystal element LCE also includes area SP where neither lower electrodes nor upper electrodes are provided.

In FIG. 12, the areas SP are provided at an end portion adjacent to the electrode C1 among end portions of the upper electrode VE5b, an end portion adjacent to the electrode C1 among end portions of the upper electrode VE6b, an end portion adjacent to the electrode C1 among end portions of the upper electrode VE7b, and an end portion adjacent to the electrode C1 among end portions of the upper electrode VE8b.

The areas SP are provided at an end portion adjacent to the electrode C3 among end portions of the upper electrode VE8a, and an end portion adjacent to the electrode C3 among end portions of the upper electrode VE8b.

The areas SP are provided between the upper electrode VE5b and the upper electrode VE9b, between the upper electrode VE6b and the upper electrode VE10b, between the upper electrode VE7b and the upper electrode VE11b, and between the upper electrode VE8b and the upper electrode VE12b.

The areas SP are provided at an end portion adjacent to the electrode C4 among the upper electrode VE9a, an end portion adjacent to the electrode C4 among end portions of the upper electrode VE9b, an end portion adjacent to the electrode C4 among the upper electrode VE10a, an end portion adjacent to the electrode C4 among end portions of the upper electrode VE10b, an end portion adjacent to the electrode C4 among the upper electrode VE11a, an end portion adjacent to the electrode C4 among end portions of the upper electrode VE11b, an end portion adjacent to the electrode C4 among the upper electrode VE12a, and an end portion adjacent to the electrode C4 among end portions of the upper electrode VE12b.

The areas SP are provided between the upper electrode VE9b and the upper electrode VE13b, between the upper electrode VE10b and the upper electrode VE14b, between the upper electrode VE11b and the upper electrode VE15b, and between the upper electrode VE12b and the upper electrode VE16b.

The areas SP are provided between the upper electrode VE13a and the upper electrode VE13b, at the end portion of the upper electrode VE13b, at the end portion of the upper electrode VE14a, at the end portion of the upper electrode VE14b, between the upper electrode VE15a and the upper electrode VE15b, at the end portion of the upper electrode VE15b, at the end portion of the upper electrode VE16a, between the upper electrode VE16a and the upper electrode VE16b, and at the end portion of the upper electrode VE16b, at the end portions adjacent to the electrode C5.

The area SP is provided between the upper electrode VE14b and the upper electrode VE18b.

The areas provided between the upper electrode VE5b and the upper electrode VE9b, between the upper electrode VE6b and the upper electrode VE10b, between the upper electrode VE7b and the upper electrode VE11b, between the upper electrode VE8b and the upper electrode VE12b, between the upper electrode VE9b and the upper electrode VE13b, between the upper electrode VE10b and the upper electrode VE14b, between the upper electrode VE11b and the upper electrode VE15b, and between the upper electrode VE12b and the upper electrode VE16b has a pentagonal shape.

The other areas SP have a square shape.

The areas SP between the upper electrode VE13a and the upper electrode VE13b, at the end portion of the upper electrode VE13b, between the upper electrode VE15a and the upper electrode VE15b, at the end portion of the upper electrode VE15b, at the end portion of the upper electrode VE16a, between the upper electrode VE16a and the upper electrode VE16b, and at the end portion of the upper electrode VE16b are particularly referred to as areas SPb. Since the area SPb overlaps with the wires, light is blocked even in white display.

The lower electrode LE connected to the electrode C1, the electrode C2, and the electrode C3 arranged near the center exists in the area SPb, and light blocked in response to the lower electrode LE of the area SPb, under the condition that black display is made in the areas of electrode C1, electrode C2, and electrode C3.

For example, when the area SPb occurs in the first quadrant (upper right area), second quadrant (upper left area), and fourth quadrant (lower right area) among the areas of the electrode C4 and the electrode C5, a light shielding pattern is entirely displayed in the third quadrant (lower left area) and the electrode C1, the electrode C2, and the electrode C3.

In contrast, the area SP which light is transmitted is an area of the gap GP between the upper electrodes VE, which is an area where there is no lower electrode LE for individually moving the electrodes near the center.

Since neither the upper electrode nor the lower electrode is provided in the areas SP other than the area SPb, light is transmitted even if the black display is made. Therefore, the area SP may be detected as a white dot but may be small compared to the area where black display is made, which does not affect the accuracy of electronic equipment.

In this configuration example as well, the same advantages as those in the embodiment can be obtained.

In the present disclosure, the upper electrode UE1, the upper electrode UE2, the upper electrode UE3, the upper electrode UE4, and the upper electrode UE5 are referred to as the first upper electrode, the second upper electrode, the third upper electrode, the fourth upper electrode, and the fifth upper electrode, respectively. The lower electrode LE1, the lower electrode LE2, the lower electrode LE3, the lower electrode LE4, and the lower electrode LE5 are referred to as the first lower electrode, the second lower electrode, the third lower electrode, the fourth lower electrode, and the fifth lower electrode, respectively.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a first upper electrode;
a second upper electrode;
a third upper electrode;
a fourth upper electrode;
a fifth upper electrode;
a first lower electrode connected to the first upper electrode;
a second lower electrode connected to the second upper electrode;
a third lower electrode connected to the third upper electrode;
a fourth lower electrode connected to the fourth upper electrode;
a fifth lower electrode connected to the fifth upper electrode;
an insulating layer provided between the first upper electrode, the second upper electrode, the third upper electrode, the fourth upper electrode, and the fifth upper electrode, and the first lower electrode, the second lower electrode, the third lower electrode, the fourth lower electrode, and the fifth lower electrode;
a counter-electrode facing the first upper electrode, the second upper electrode, the third upper electrode, the fourth upper electrode, and the fifth upper electrode, the first lower electrode, the second lower electrode, the third lower electrode, the fourth lower electrode, and the fifth lower electrode, wherein
the second lower electrode overlaps with the first upper electrode and the second upper electrode,
the third lower electrode overlaps with the first upper electrode and the third upper electrode,
the fourth lower electrode overlaps with the second upper electrode, the third upper electrode, and the fourth upper electrode, and
the fifth lower electrode overlaps with the second upper electrode, the third upper electrode, and the fifth upper electrode.

2. The electronic device according to claim 1, wherein
each of the first upper electrode, the second upper electrode, the third upper electrode, the fourth upper electrode, the fifth upper electrode, the first lower electrode, the second lower electrode, the third lower electrode, the fourth lower electrode, and the fifth lower electrode, is formed of a transparent conductive material.

3. The electronic device according to claim 1, wherein
the first upper electrode has a square shape in plan view, and
the second upper electrode, the third upper electrode, the fourth upper electrode, and the fifth upper electrode constitute a hollow square electrode surrounding the first upper electrode.

4. The electronic device according to claim 1, wherein
gaps are provided between the first upper electrode, the second upper electrode, the third upper electrode, the fourth upper electrode, and the fifth upper electrode.

5. The electronic device according to claim 1, further comprising:
a counter-electrode; and
a liquid crystal layer, wherein
the first upper electrode, the second upper electrode, the third upper electrode, the fourth upper electrode, and the fifth upper electrode are referred to as upper electrodes,
the first lower electrode, the second lower electrode, the third lower electrode, the fourth lower electrode, and the fifth lower electrode are referred to as lower electrodes, and
the liquid crystal layer is arranged between the upper electrodes and the lower electrodes, and the counter-electrode.

6. The electronic device according to claim 1, further comprising:
an imaging device including a sensor element.

7. An electronic device comprising:
an upper electrode;
a lower electrode; and
an area where the upper electrode and the lower electrode are not provided, wherein
the upper electrode includes
a center electrode having a circular shape,
a first peripheral electrode surrounding the center electrode and having an annular shape,
a second peripheral electrode surrounding the first peripheral electrode and having an annular shape,
a third peripheral electrode surrounding the second peripheral electrode and having an annular shape, and
a fourth peripheral electrode surrounding the third peripheral electrode and having an annular shape, and
each of the center electrode, the first peripheral electrode, the second peripheral electrode, the third peripheral electrode, and fourth peripheral electrode includes a plurality of divisional electrodes.

8. The electronic device according to claim 7, wherein
each of the center electrode, the first peripheral electrode, the second peripheral electrode, the third peripheral electrode, and fourth peripheral electrode is formed of a transparent conductive material.

9. The electronic device according to claim 7, wherein
gaps are provided between the center electrode, the first peripheral electrode, the second peripheral electrode, the third peripheral electrode, and fourth peripheral electrode.

10. The electronic device according to claim 7, wherein
gaps are provided between the plurality of divisional electrodes.

11. The electronic device according to claim 7, further comprising:
a counter-electrode; and
a liquid crystal layer, wherein
the liquid crystal layer is arranged between the upper electrode and the lower electrode, and the counter-electrode.

12. The electronic device according to claim 7, further comprising:
an imaging device including a sensor element.

13. The electronic device according to claim 7, wherein
the area has a pentagonal shape.

14. The electronic device according to claim 7, wherein
the area has a square shape.
